(19) United States
(12) Patent Application Publication
(10) Pub. No.: US 2006/0285574 A1
(43) Pub. Date: Dec. 21, 2006

(54) Thermal digital video camcorder having environment sensing element

(76) Inventor: Chih-Peng Chang, Longtan Shiang (TW)

Correspondence Address: TROXELL LAW OFFICE PLLC, SUITE 1404, 5205 LEESBURG PIKE, FALLS CHURCH, VA, 22041, US

(21) Appl. No.: 11/385,802

(22) Filed: Mar. 22, 2006

(30) Foreign Application Priority Data
Jun. 17, 2005 (TW) 094210335

(51) Int. Cl. G01K 1/14

(52) U.S. Cl. 374/141; 374/142

(57) ABSTRACT

The present invention senses a temperature, a humidity, a distance and a height of an on-site environment for precisely setting parameters of a digital video cam corder and for providing better protection to an operator who is taking a picture in the hazardous or special environment.

### FIELD OF THE INVENTION

The present invention relates to a thermal DVC (digital video camcorder); more particular, relates to acquiring a temperature, a humidity, a distance and a height while taking a picture in a special environment.

### DESCRIPTION OF THE RELATED ART

A reseacher may do a research in an environment with high temperature and humidity. When he wants to record his research objects, a thermal DVC is quite usually used for taking pictures. As shown in FIG. 4, the thermal DVC used may comprise a thermal image sensor 5, a digital sign a processor 6 and a monitor 7, where the thermal image sensor 5 is used to sense a thermal image of an object in front; the digital signal processor 6 connecting to the thermal image sensor 5 is used to receive signals of the thermal image and to transform the signals according to requirements; and the monitor 7 connecting to the digital signal processor 6 is used to display the thermal image transformed by the digital signal processor. By using the thermal DVC, the research objects can be recorded in the environment with high temperature and humidity.

Although the thermal DVC can record the research objects in the environment with high temperature and humidity, the recording may not function with the best parameter settings and may not obtain a picture as expected since the operator is doing his research in such a special environment.

In addition, the environment where the researcher is doing his research may do harms to his body; so, the researcher usually wears protective clothes to protect himself. Yet, because the researcher may be over-concentrated on his research and the protective clothes may prevent the researcher from awaring the temperature and humidity of the environment and the distance between the researcher and the research objects, the reseacher may be apt to be hurt and danger is so increased. Hence, the prior art does not fulfill users' requests on actual use.

### SUMMARY OF THE INVENTION

The main purpose of the present invention is to sense and to acquire a temperature, a humidity, a distance and a height of a special environment by using an environment sensing element connected to a digital signal processor of a DVC when an operator is taking a picture in the special environment.

To achieve the above purpose, the present invention is a thermal DVC having an environment sensing element, comprising a thermal image sensor to sense a thermal image of an object in front; a digital signal processor connecting to the thermal image sensor to receive signals of the thermal image and to transform the signals according to requirements; a monitor connecting to the digital signal processor to display the thermal image transformed by the digital signal processor; and an environment sensing element connecting to the digital signal processor to sense a temperature, a humidity, a distance and a height of a on-site environment to be displayed with their numbers on the monitor. Accordingly, a novel thermal DVC having an environment sensing element is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a perspective view of a preferred embodiment according to the present invention;

FIG. 2 is a block view of the preferred embodiment according to the present invention;

FIG. 3 is a block view showing a state of use of the preferred embodiment according to the present invention; and

FIG. 4 is a block view of a prior art.

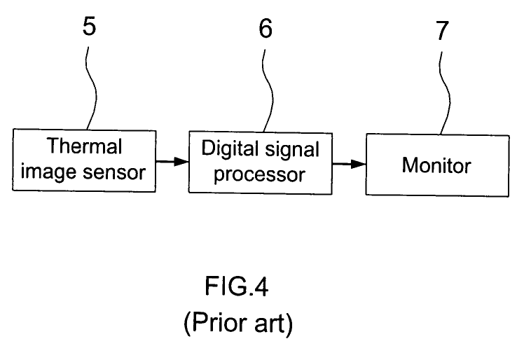

### DESCRIPTION OF THE PREFERRED EMBODIMENT

The following description of the preferred embodiment is provided to understand the features and the structures of the present invention.

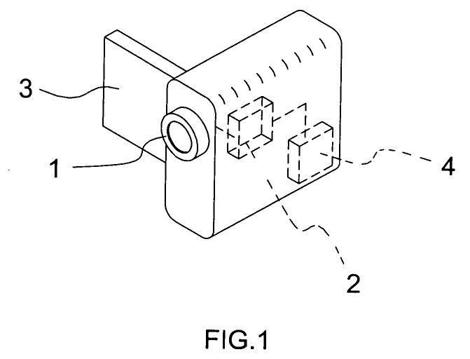

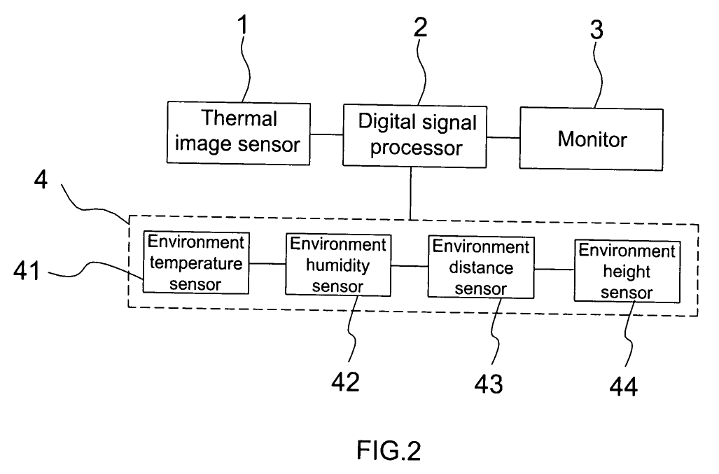

Please refer to FIG. 1 and FIG. 2, which are a perspective view and a block view of a preferred embodiment according to the present invention. As shown in the figures, the present invention is a thermal DVC (digital video camcorder) having an environment sensing element, comprising a thermal image sensor 1, a digital signal processor 2, a monitor 3 and an environment sensing element, where a temperature, a humidity, a distance and a height of an on-site environment are sensed by using the environment sensing element 4.

The thermal image sensor 1 is used to sense a thermal image of an object in front.

The digital signal processor 2 is connected to the thermal image sensor 1 to receive signals of the thermal image of the object sensed and to transform the signals as required.

The monitor 3 is connected to the digital signal processor 2 to display the thermal image of the object transformed by the digital signal processor 2.

The environment sensing element 4 is connected to the digital signal processor 2 to sense the temperature, the humidity, the distance, and the height of the on-site environment; and the temperature, the humidity, the distance, and the height of the on-site environment are displayed by the monitor 3, where the temperature in a range between −20° C. and 500° C. is sensed by using a temperature sensor 41; the humidity is sensed by using a humidity sensor 42 the distance by using a distance sensor 43; and the height, a height sensor 44.

Thus, a novel thermal DVC having an environment sensing element is obtained.

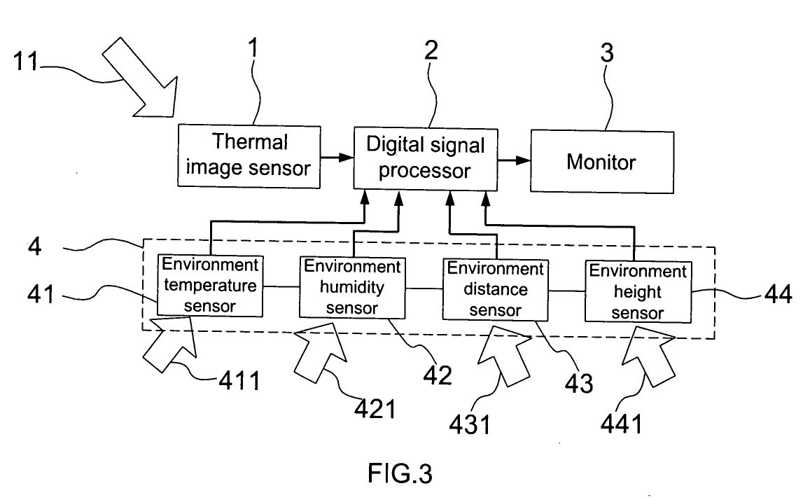

Please refer to FIG. 3, which is a block view showing a state of use of the preferred embodiment according to the present invention. As shown in the figure, when an operator operates the present invention in a special environment (such as an environment having high temperature, high humidity or dryness), an object in front is aimed at by a thermal image sensor 1 for taking a picture of the object with temperature sensed by the thermal image sensor 1. Signals of the temperature of the object in front is received by a digital signal processor 2; and the signals of the image for the temperature of the object is transformed according to requirements. The transformed temperature image of the object is displayed by using a monitor 3. Thus, a picture taken in the special environment is obtained.

When the picture in the special environment is being taken, the operator wears protective clothes for safe protection and is so isolated to the outside environment. Hence, an environment sensing element 4 uses a temperature sensor 41 to sense a temperature 411 of the outside environment; a humidity sensor 42, a humidity 421; a distance sensor 43, a distance 431; and a height sensor 44, a height 441. After the sensing done by using the environment sensing element 4, signals of the temperature 411, the humidity 421, the distance 431 and the height 421 are received by the digital signal processor 2 and are transformed according to requirements. In the end, an information of the temperature 411, the humidity 421, the distance 431 and the height 421 is displayed on the monitor 3 so that the operator is aware of the danger of the outside environment for better preparation and handling.

Nevertheless, it is quite important to acquire environmental paramters for the thermal image sensor 1. For example, on different heights in the atmosphere, the densities of H₂O and CO₂ differ. And the environmental paramters like these may directly affect parameter settings of the thermal image sensor 1 and so affect the picture taken.

To sum up, the present invention is a thermal DVC having an environment sen sing element, where, by using the environment sensing element connecting to a digital signal processor of the DVC, an operator is aware of the temperature and the humidity of the environment and the distance between the operator and the heat source for a better self-protection and better settings of the DVC when the operator is taking a picture in a special environment.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A thermal DVC (digital video camcorder) having an environment sensing element,
comprising a thermal image sensor sensing a thermal image of an object in front of said thermal image sensor; a digital signal processor connecting to said thermal image sensor to receive signals of said thermal image of said object and to transform signals; and a monitor connecting to said digital signal processor to display said signals of said thermal image of said object transformed by said digital signal processor,
characterized in that an environment sensing element is connected to said digital signal processor, said environment sensing element sensing a temperature, a humidity and a distance of an on-site environment, said temperature, said humidity and said distance displayed by said monitor.

2. The thermal DVC according to claim 1, wherein said environment sensing element senses said temperature of said on-site environment by using a temperature sensor.

3. The thermal DVC according to claim 1, wherein said temperature sensor senses a temperature in a range between −20° C. and 500° C.

4. The thermal DVC according to claim 1, wherein said environment sensing element senses said humidity of said on-site environment by using a humidity sensor.

5. The thermal DVC according to claim 1, wherein said environment sensing element senses said distance of said on-site environment by using a distance sensor.

6. The thermal DVC according to claim 1, wherein said environment sensing element further senses a height of said on-site environment by using a height sensor.
